(19) United States
(12) Patent Application Publication
(10) Pub. No.: US 2014/0251085 A1
(43) Pub. Date: Sep. 11, 2014

(54) SOFT MAGNETIC METAL POWDER AND POWDER CORE

(71) Applicants: Mikiko Tsutsui, Nagoya-shi (JP); Yuichiro Fujita, Nagoya-shi (JP)

(72) Inventors: Mikiko Tsutsui, Nagoya-shi (JP); Yuichiro Fujita, Nagoya-shi (JP)

(21) Appl. No.: 14/197,021

(22) Filed: Mar. 4, 2014

(30) Foreign Application Priority Data
Mar. 5, 2013 (JP) 2013-042706

(51) Int. Cl. H01F 1/22; H01F 1/20

(52) U.S. Cl. CPC H01F 1/22; H01F 1/20
USPC 75/246; 420/117; 420/104; 420/8

(57) ABSTRACT

The present invention provides a powder core used for high-frequency magnetic components and a soft magnetic metal powder which is suitable for the manufacturing of the above-described powder core. The invention relates to a soft magnetic metal powder, consisting of, in terms of mass %: 0.5% to 10.0% of Si, 1.5% to 8.0% of Cr, and 0.05% to 3.0% of Sn, with the balance being Fe and unavoidable impurities.

The present invention relates to a soft magnetic metal powder and a powder core obtained using the same, and particularly to a powder core used for high-frequency magnetic components and a soft magnetic metal powder therefor.

### BACKGROUND OF THE INVENTION

In the case where an attempt is made to improve the performance of digital electronic devices and decrease the size and weight thereof, due to the necessity of making electronic circuits operate at a higher frequency, there is a demand for electronic components used for the electronic devices, for example, magnetic components (or magnetic elements) such as choke coils or inductors being optimized at a higher frequency. For example, while cheap ferrite oxides having high permeability have been used for magnetic components of the related art, in magnetic cores made of the above-described ferrite oxide, there is a tendency of core loss (loss) becoming significantly great at a high frequency of several MHz or higher. Therefore, a powder core obtained by insulating and compressing soft magnetic powder can be used. Compared with bulk-form magnetic cores made of a ferrite oxide, the powder core causes small core loss at a high frequency and, furthermore, can maintain high permeability even at a high current.

However, the eddy current-caused loss (eddy current loss) generated by a magnetic field makes a larger contribution to the core loss at a high frequency. An energy corresponding to the eddy current loss causes a decrease in the operation efficiency of magnetic components, and also is emitted in a form of heat so as to form an obstructive factor against a decrease in the size of electronic devices. In the case where suppressing the eddy current loss in the powder cores, it is considered effective to decrease the average particle diameter of soft magnetic powder that forms the powder cores.

For example, Patent Document 1 describes that, in a powder core as well, the eddy current loss abruptly increases at a high operation frequency in a range of several tens of kilohertz to several hundreds of kilohertz, and discloses a powder core obtained by pressure-forming soft magnetic powder made of an Fe—Si—Cr ternary alloy for which a predetermined average particle diameter and a predetermined maximum particle diameter are specified. In a powder core obtained from soft magnetic powder having a small average particle diameter, the flow channel of an eddy current becomes short so that the eddy current loss can be decreased; however, in the case where the average particle diameter is too small, a decrease in the permeability due to poor pressure-forming is caused. Furthermore, in the case where manufacturing soft magnetic powder, according to an atomizing method, it is possible to efficiently manufacture powder having a small particle diameter, to form the respective particles of the powder in a substantially spherical shape so as to increase the filling rate during pressure-forming, and to produce a powder core having a higher density so as to supply high permeability and high magnetic flux density.

As soft magnetic powder for the above-described powder core, an Fe—Si binary alloy made of a component composition of a silicon steel sheet that has been thus far used for cores of magnetic components or an Fe—Si—Cr ternary alloy obtained by adding non-magnetic Cr to the Fe—Si binary alloy in order to enhance corrosion resistance is frequently used.

For example, Patent Document 2 discloses soft magnetic powder which is made of an Fe—Si binary alloy containing 0.5 mass % to 8.0 mass % of Si and in which the average crystal grain diameter of crystal grains among powder particles is set in a predetermined range with respect to the excitation frequency of the powder core of up to approximately 200 kHz. C, N, Mn, P, S, Cu, Ni, Cr, Mo, Co, Ti, Sn, Nb, Zr, Al and the like can be added as long as the above-described characteristic is not affected. Patent Document 2 describes that the core loss is dependent on the crystal grain diameter of powder particles, and there is a crystal grain diameter at which the core loss is suppressed to a predetermined excitation frequency.
[Patent Document 1] JP-A-2011-049568
[Patent Document 2] JP-A-2008-124270

### SUMMARY OF THE INVENTION

As described above, regarding the powder core obtained by pressure-forming a soft magnetic powder, the adjustment of the particle diameter of the soft magnetic powder or the crystal grain diameter of powder particles is proposed as a method for optimizing an operating frequency on a high frequency side. The above-described adjustment can be carried out by controlling the manufacturing conditions of soft magnetic powder. However, in actual cases, it is very difficult to stably obtain soft magnetic powder having a crystal grain diameter at which the core loss is minimized while controlling the manufacturing conditions as described in Patent Document 2.

The invention has been made in consideration of the above-described status, and an object of the invention is to provide a powder core used for high-frequency magnetic components and a soft magnetic metal powder which is suitable for the manufacturing of the above-described powder core. Moreover, the object of the invention is to provide the powder core which has sufficient permeability and sufficient corrosion resistance, and can decrease the core loss within an operating frequency range on a high frequency side of several hundreds of kilohertz or more.

The present inventors have considered what makes it possible to stably manufacture a soft magnetic metal powder having a crystal grain diameter at which the above-described core loss can be decreased by adjusting the component composition of metal powder, and have completed the invention while thoroughly conducting studies. That is to say, the invention provides a soft magnetic metal powder, consisting of, in terms of mass %:0.5% to 10.0% of Si, 1.5% to 8.0% of Cr, and 0.05% to 3.0% of Sn, with the balance being Fe and unavoidable impurities.

According to the above-described invention, in the case where a predetermined amount of non-magnetic Sn is added to a predetermined Fe—Si—Cr-based alloy, it is possible to efficiently manufacture a soft magnetic metal powder which has a smaller average particle diameter and is more spherical, and it is possible to minimize crystal grains which are present in the soft magnetic metal powder. The powder core obtained by using the soft magnetic metal powder can suppress the eddy current loss within an operating frequency range on a high frequency side of several hundreds of kilohertz without sacrificing permeability and corrosion resistance thereof, whereby the core loss is decreased, and the DC superposition characteristics required for power supply use are improved.

Moreover, the invention provides a powder core of obtained by pressure-forming a soft magnetic metal powder, in which the soft magnetic metal powder consists of: 0.5% to 10.0% of Si, 1.5% to 8.0% of Cr, and 0.05% to 3.0% of Sn, with the balance being Fe and unavoidable impurities.

According to the above-described invention, it is possible to supply the powder core which has high permeability and favorable corrosion resistance, can decrease the core loss within an operating frequency range on a high frequency side of several hundreds of kilohertz or more, and, furthermore, is also excellent in terms of DC superposition characteristics that are particularly required for power supply use.

### BRIEF DESCRIPTION OF THE DRAWINGS

FIG. 1 is a diagram illustrating a method for manufacturing a soft magnetic metal powder and a powder core.

FIG. 2 is a perspective view of the powder core used in the evaluation test.

FIG. 3(A) and FIG. 3(B) are SEM photographs of the soft magnetic metal powder.

FIG. 4 is a graph illustrating a relationship between a fraction of an eddy current loss in iron loss of the powder core and an added amount of Sn.

### DETAILED DESCRIPTION OF THE INVENTION

A soft magnetic metal powder for powder cores according to the invention is an alloy obtained by adding a predetermined amount of non-magnetic Sn to an Fe—Si—Cr-based alloy, and the soft magnetic metal powder has a component composition in which, in terms of mass %, Si is set in a range of 0.5% to 10.0%, Cr is set in a range of 1.5% to 8.0%, and Sn is set in a range of 0.05% to 3.0%. In the case where a predetermined amount of Cr is added to an Fe—Si-based alloy for the improvement of corrosion resistance, and a predetermined amount of non-magnetic Sn is added, it is possible to efficiently manufacture a soft magnetic metal powder which has a smaller average particle diameter and is more spherical, and it is possible to minimize crystal grains which are present in the soft magnetic metal powder. The powder core obtained by using the soft magnetic metal powder can suppress the eddy current loss which is considered as a particular problem within an operating frequency range on a high frequency side of several hundreds of kilohertz without sacrificing permeability and corrosion resistance thereof, whereby the core loss is decreased, and the DC superposition characteristics are improved.

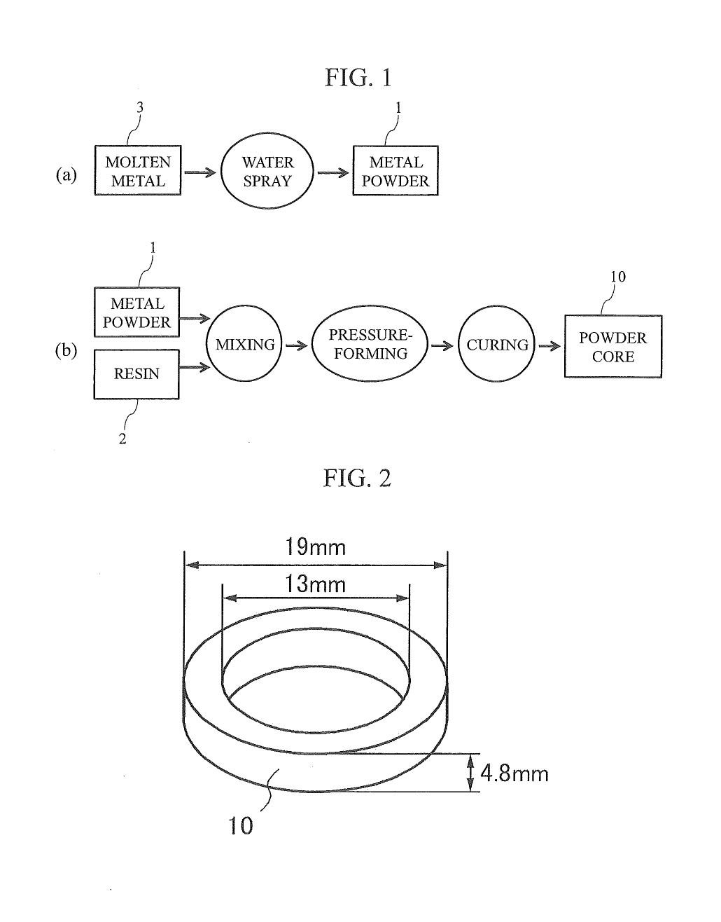

Hereinafter, a method for manufacturing a soft magnetic metal powder and a method for manufacturing a powder core using the above-described soft magnetic metal powder (hereinafter, referred to simply as “metal powder”) which are examples of the invention will be described using FIG. 1.

As illustrated in FIG. 1(a), metal powder 1 was manufactured using a water atomizing method in which water is blown onto molten metal 3 made of an Fe—Si—Cr—Sn-based alloy having a component composition described below so as to atomize the alloy. Meanwhile, while the metal powder 1 can also be manufactured using other well-known methods, in particular, according to the above-described water atomizing method, it is possible to stably manufacture the metal powder 1 which has a spherical shape with a relatively small average particle diameter and has fine crystal grains therein.

Next, as illustrated in FIG. 1(b), an insulating resin 2 is mixed as a binder with the metal powder 1, the mixture is loaded into a mold having a predetermined shape, and is pressure-formed using a press. Here, the metal powder 1 which is appropriately classified to adjust the particle diameter may be used. Meanwhile, as the insulating resin 2, it is possible to use a single body or a mixture of a plurality of a variety of coupling agents such as a silane-based coupling agent, a titanium-based coupling agent and an aluminum-based coupling agent, or resins such as a silicone resin, an epoxy resin, an acryl resin and a butyral resin. Subsequently, in the case where the resin 2 is cured by carrying out a thermal treatment on a compact removed from the mold, it is possible to obtain a powder core 10. Meanwhile, it is also possible to manufacture a composite magnetic body (magnetic core) using a method in which the mixture is injection-molded using an injection molder (including transfer molding), a cast molding method such as potting, or a molding method through printing instead of the method in which the mixture is pressure-formed using a press.

Subsequently, the results of manufacturing metal powder having different component compositions using the above-described manufacturing method, manufacturing powder cores, and carrying out a variety of tests will be described.

[Previous Test]

To confirm the influence of Sn on the particle diameter of the obtained metal powder, metal powder having a different amount of Sn was manufactured using the water atomizing method, and the average particle diameter D50 was measured. What has been described above is summarized in Table 1. Meanwhile, regarding the component compositions, since Comparative Example 1a corresponds to Comparative Example 1 described below, and Example 1a corresponds to Example 1 described below, Comparative Examples 1a and 1b and Examples 1a to 5a are used in the table. In addition, the component compositions are identical for alloys to be atomized and the obtained metal powder.

TABLE 1

| | | | | | Average particle |
|---|---|---|---|---|---|
| | | | | | diameter D50 |
| | Component composition (mass %) | | | | before classifi- |
| | Fe | Si | Cr | Sn | cation (μm) |
| Comparative | balance | 3.5 | 4 | 0 | 15.7 |
| Example 1a | | | | | |
| Example 1a | balance | 3.5 | 4 | 0.05 | 15.3 |
| Example 2a | balance | 3.5 | 4 | 0.2 | 14.5 |
| Example 3a | balance | 3.5 | 4 | 0.5 | 13.6 |
| Example 4a | balance | 3.5 | 4 | 0.7 | 13.0 |
| Example 5a | balance | 3.5 | 4 | 1 | 12.7 |
| Example 6a | balance | 3.5 | 4 | 2 | 12.4 |
| Example 7a | balance | 3.5 | 4 | 3 | 12.0 |
| Comparative | balance | 3.5 | 4 | 4 | 11.8 |
| Example 2a | | | | | |

(1) Test Method

Fe—Si—Cr—Sn-based alloys having the respective component compositions illustrated in Table 1 were prepared, and metal powder was manufactured using the water atomizing method. For the obtained metal powder, the average particle diameters D50 were measured using a laser diffraction particle size distribution measurement apparatus.

(2) Test Results

As illustrated in Table 1, the average particle diameter D50 tended to decrease as the amount of Sn in the component composition increased. In detail, the average particle diameter D50 reached the maximum at 15.7 μm in Comparative Example 1a containing no Sn, and the average particle diameter D50 reached the minimum at 11.8 μm in Comparative Example 2a having an amount of Sn set to 4 mass %. As the amount of Sn gradually increases in an order of Examples 1a to 7a, the average particle diameters D50 decreased. That is, in the case where an attempt was made to obtain metal powder having a predetermined average particle diameter by classifying the metal powder, as the amount of Sn in the component composition increases, the yield of the metal powder having a small average particle diameter D50 increases.

[Evaluation Test]

Next, to confirm the influence of the component composition on magnetic characteristics, metal powder was manufactured from the molten steel 3 having different component compositions using the water atomizing method, classified, and then cores (powder cores) were manufactured using metal powder having an adjusted particle diameter (some of the metal powder was not classified, as will be described below), and a variety of evaluation tests were carried out. What has been described above was summarized in Tables 2 to 5.

TABLE 2

| | | | | | Average | | | | | |
|---|---|---|---|---|---|---|---|---|---|---|
| | Component composition | | | | particle | | DC magnetic | | | |
| | (mass %) | | | | diameter | Initial | field application | Iron loss | Corrosion | Comprehensive |
| | Fe | Si | Cr | Sn | D50 (μm) | permeability | (Oe) | (kW/m³) | resistance | determination |
| Comparative | balance | 3.5 | 4 | 0 | 11.9 | 34 | 86 | 7419 | No | X |
| Example 1 | | | | | | | | | | |
| Example 1 | balance | 3.5 | 4 | 0.05 | 11.4 | 34 | 86 | 7378 | Yes | ◯ |
| Example 2 | balance | 3.5 | 4 | 0.2 | 10.6 | 35 | 84 | 7228 | Yes | ◯ |
| Example 3 | balance | 3.5 | 4 | 0.5 | 11.8 | 34 | 87 | 7084 | Yes | ◯ |
| Example 4 | balance | 3.5 | 4 | 0.7 | 11.2 | 33 | 92 | 7053 | Yes | ◯ |
| Example 5 | balance | 3.5 | 4 | 1 | 11.8 | 31 | 101 | 6856 | Yes | ◯ |
| Example 6 | balance | 3.5 | 4 | 2 | 10.9 | 28 | 109 | 6844 | Yes | ◯ |
| Example 7 | balance | 3.5 | 4 | 3 | 11.1 | 24 | 115 | 6767 | Yes | ◯ |
| Comparative | balance | 3.5 | 4 | 4 | 11.8 | 21 | 118 | 6676 | Yes | X |
| Example 2 | | | | | | | | | | |

TABLE 3

| | | | | | Average | | DC magnetic | | |
|---|---|---|---|---|---|---|---|---|---|
| | Component composition | | | | particle | | field | | |
| | (mass %) | | | | diameter | Initial | application | Iron loss | Comprehensive |
| | Fe | Si | Cr | Sn | D50 (μm) | permeability | (Oe) | (kW/m³) | determination |
| Comparative | balance | 0 | 4 | 1 | 10.5 | 27 | 147 | 15231 | X |
| Example 3 | | | | | | | | | |
| Example 8 | balance | 0.5 | 4 | 1 | 11.1 | 31 | 121 | 7396 | ◯ |
| Example 9 | balance | 1 | 4 | 1 | 11.7 | 32 | 116 | 7334 | ◯ |
| Example 10 | balance | 1.5 | 4 | 1 | 10.9 | 34 | 111 | 7297 | ◯ |
| Example 11 | balance | 2 | 4 | 1 | 11.2 | 33 | 109 | 7209 | ◯ |
| Example 12 | balance | 2.5 | 4 | 1 | 10.7 | 33 | 104 | 7165 | ◯ |
| Example 5 | balance | 3.5 | 4 | 1 | 11.8 | 31 | 101 | 6856 | ◯ |
| Example 13 | balance | 6.5 | 4 | 1 | 11.2 | 29 | 92 | 4999 | ◯ |
| Example 14 | balance | 8 | 4 | 1 | 11.3 | 28 | 89 | 3727 | ◯ |
| Example 15 | balance | 10 | 4 | 1 | 11.4 | 28 | 81 | 3513 | ◯ |
| Comparative | balance | 11 | 4 | 1 | 10.6 | 26 | 72 | 3498 | X |
| Example 4 | | | | | | | | | |

TABLE 4

| | | | | | Average | | DC magnetic | | | |
|---|---|---|---|---|---|---|---|---|---|---|
| | Component composition | | | | particle | | field | | | |
| | (mass %) | | | | diameter | Initial | application | Iron loss | Corrosion | Comprehensive |
| | Fe | Si | Cr | Sn | D50 (μm) | permeability | (Oe) | (kW/m³) | resistance | determination |
| Comparative | balance | 3.5 | 1 | 1 | 10.7 | 34 | 116 | 5744 | No | X |
| Example 5 | | | | | | | | | | |
| Example 16 | balance | 3.5 | 1.5 | 1 | 11.2 | 33 | 112 | 6002 | Yes | ◯ |
| Example 17 | balance | 3.5 | 2 | 1 | 11.6 | 32 | 109 | 6274 | Yes | ◯ |
| Example 18 | balance | 3.5 | 3 | 1 | 11.9 | 32 | 104 | 6433 | Yes | ◯ |
| Example 5 | balance | 3.5 | 4 | 1 | 11.8 | 31 | 101 | 6856 | Yes | ◯ |
| Example 19 | balance | 3.5 | 6 | 1 | 12.1 | 28 | 102 | 6891 | Yes | ◯ |
| Example 20 | balance | 3.5 | 7 | 1 | 11.1 | 27 | 101 | 7009 | Yes | ◯ |
| Example 21 | balance | 3.5 | 8 | 1 | 11.5 | 25 | 98 | 7370 | Yes | ◯ |
| Comparative | balance | 3.5 | 9 | 1 | 10.9 | 24 | 94 | 7627 | Yes | X |
| Example 6 | | | | | | | | | | |

TABLE 5

| | | | | | Average | | DC magnetic | | |
|---|---|---|---|---|---|---|---|---|---|
| | Component composition | | | | particle | | field | | |
| | (mass %) | | | | diameter | Initial | application | Iron loss | Comprehensive |
| | Fe | Si | Cr | Sn | D50 (μm) | permeability | (Oe) | (kW/m³) | determination |
| Comparative | balance | 8 | 4 | 0 | 11.2 | 30 | 73 | 3924 | X |
| Example 7 | | | | | | | | | |
| Example 14 | balance | 8 | 4 | 1 | 11.3 | 28 | 89 | 3727 | ◯ |
| Example 22 | balance | 8 | 4 | 1 | 25.4 | 34 | 82 | 4930 | ◯ |
| Example 23 | balance | 8 | 4 | 1 | 37.9 | 37 | 80 | 6122 | ◯ |
| Example 24 | balance | 6.5 | 5 | 0.2 | 11.7 | 30 | 88 | 5719 | ◯ |

(1) Manufacturing of Metal Powder

Alloys having the respective component compositions illustrated in Tables 2 to 5 were prepared, and metal powder was manufactured using the water atomizing method. Except for Examples 22 and 23 (refer to Table 5), the obtained metal powder was classified using a 20 μm sieve. As illustrated in the Tables as well, as a result of measuring the average particle diameter D50 using a laser diffraction particle size distribution measurement apparatus, except for Examples 22 and 23, it was possible to adjust the average particle diameter D50 to approximately 10 μm to 12 μm. Meanwhile, in Examples 22 and 23, metal powder having a relatively large average particle diameter D50 is manufactured under changed manufacturing conditions, such as spray pressure, in the water atomizing method and used.

(2) Manufacturing of Cores (Powder Cores) for Tests

Each metal powder was processed into ring-shaped toroidal cores 10 having an outer diameter φ of 19 mm, an inner diameter φ of 13 mm and a thickness of 4.8 mm illustrated in FIG. 2. That is, 2.5 parts by mass of an epoxy resin was added to 100 parts by mass of the metal powder as a binder, predetermined metal powder was mixed, dispersed and loaded into a mold, and the metal powder was compressed by supplying a surface pressure of 6 ton/cm². A compact was held at 170° C. for 1 hour in the atmosphere so as to cure the epoxy resin, thereby obtaining a core 10.

(3) Measurement of Magnetic Characteristics

The initial permeability, DC magnetic field application and iron loss (core loss) of the core 10 were evaluated respectively as described below.

The initial permeability was measured using an LCR meter (4284A) manufactured by Agilent Technologies at a frequency of 1 MHz and 0.5 mA by supplying 160 turns of a winding wire to the core 10. In addition, the DC magnetic field application was obtained by measuring the value of a DC magnetic field in the case where 160 turns of a winding wire was supplied to the core 10, the DC magnetic field was superposed while applying a current having a frequency of 10 kHz using the same LCR meter, and the initial permeability was decreased by 20%.

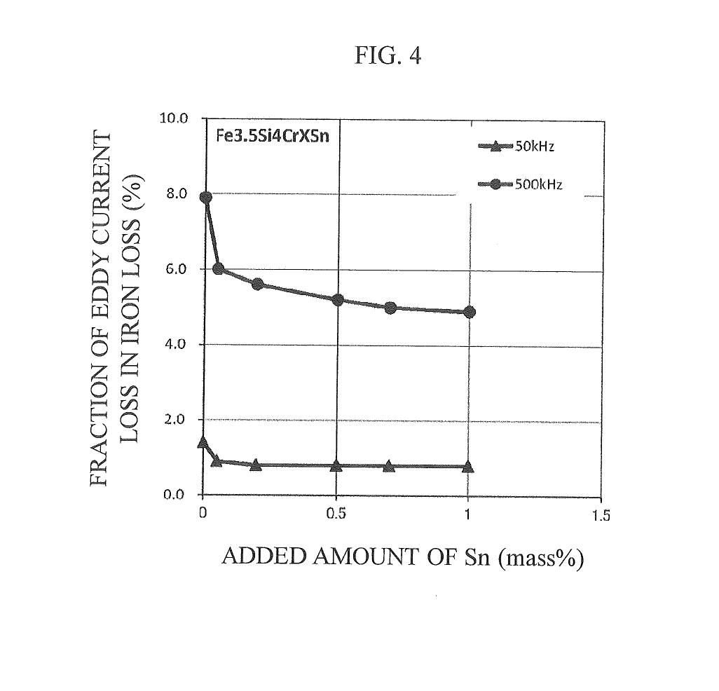

The iron loss was measured using a B-H analyzer (SY-8258) manufactured by Iwatsu Test Instruments Corporation under the conditions of a magnetic flux density of 0.05 T and a frequency of 500 kHz by supplying 40 turns of a winding wire to a primary side of the core 10 and 8 turns of a winding wire to a secondary side. In addition, an eddy current loss was computed by subtracting the respective hysteresis losses from the iron loss, and the fraction of the eddy current loss in the iron loss was obtained (refer to FIG. 4).

The hysteresis loss was computed by fixing the magnetic flux density using the same B-H analyzer as described above, and measuring the iron losses at the respective frequencies while changing the frequency. That is, the measured values of the iron loss at the respective frequencies are divided by the frequencies, and a graph is produced with respect to the frequencies. The value of a segment extrapolated up to a frequency of 0 kHz is considered as the hysteresis loss coefficient. Furthermore, hysteresis losses at the respective frequencies were computed by multiplying the hysteresis loss coefficient by the frequencies.

(4) Evaluation of Corrosion Resistance

The corrosion resistance was evaluated by leaving the core 10 in a constant temperature and humidity room maintained at a temperature of 85° C. and a relative humidity of 85% for 500 hours, and visually observing the occurrence of discoloration on the surface of the core.

(5) Test Results

First, the results of the magnetic characteristics and corrosion resistance of the core obtained from the metal powder having different amounts of Sn will be described.

As illustrated in Table 2, the initial permeability tended to decrease as the amount of Sn in the component composition increases. In detail, the initial permeability in Comparative Example 1 containing no Sn (34), Example 1 having an amount of Sn set to 0.05 mass % (34), and Example 2 having an amount of Sn set to 0.2 mass % (35) became similar, decreased as the amount of Sn gradually increased in an order of Examples 3 to 7, and became the minimum in Comparative Example 2 having an amount of Sn set to 4 mass % (21). That is, the initial permeability decreases as the added amount of non-magnetic Sn increases.

The DC magnetic field application tended to increase as the amount of Sn in the component composition increased. In detail, the DC magnetic field application in Comparative Example 1 containing no Sn and Example 1 having an amount of Sn set to 0.05 mass % (86 Oe), and Example 2 having an amount of Sn set to 0.2 mass % (84 Oe), increased as the amount of Sn gradually increased in an order of Examples 3 to 7, and reached the maximum in Comparative Example 2 having an amount of Sn set to 4 mass % (118 Oe). That is, it is possible to increase the DC superposition characteristics by increasing the added amount of Sn.

The iron loss tended to decrease as the amount of Sn in the component composition increased. In detail, the iron loss reached the maximum in Comparative Example 1 containing no Sn (7419 kW/m³), and reached the minimum in Comparative Example 2 having an amount of Sn set to 4 mass % (6676 kW/m³). The iron loss decreased as the amount of Sn increased in an order of Examples 1 to 7. That is, it is possible to decrease the iron loss by increasing the added amount of Sn.

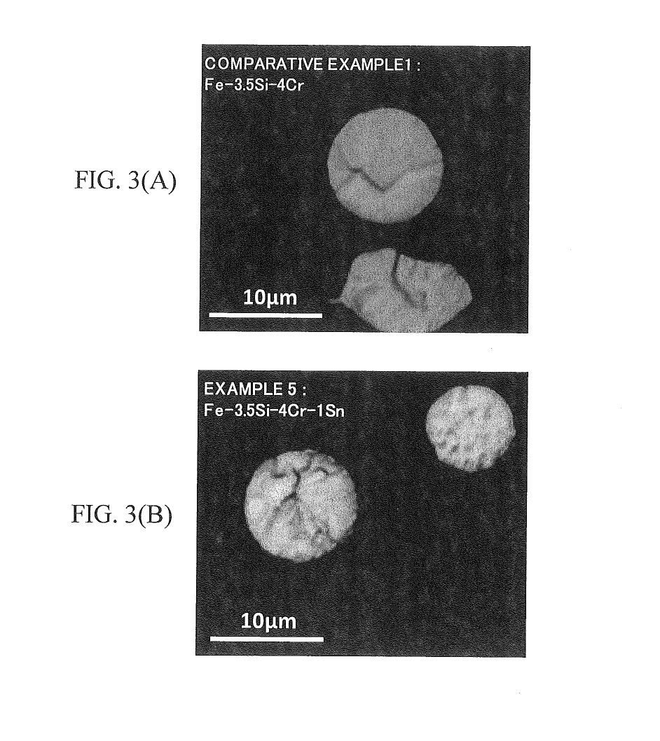

Here, FIG. 3(A) illustrated average particles of metal powder containing no Sn in the component composition (Comparative Example 1). In addition, FIG. 3(B) illustrated average particles of metal powder containing 1 mass % of Sn (Example 5). Particles of Comparative Example 1 have an irregular shape, but particles of Example 5 have a more spherical shape. It is considered that, in the case where Sn is contained in the component composition, the viscosity of the molten metal 3 during atomizing decreases, and the shape of the particles becomes more spherical. Furthermore, particles of Example 5 include inner crystal particles smaller than the particles of Comparative Example 1. In the case where FIG. 4 is referenced along with FIG. 3(A) and FIG. 3(B), in the cores 10 obtained from the metal powder 1 of Comparative Example 1 and Examples 1 to 5, in the case where Sn is contained in the component composition, the fraction of the eddy current loss in the iron loss abruptly decreases, and the fraction tends to further decrease along with the content. The above-described tendency becomes significant on a high frequency side of 500 kHz compared with at 50 kHz.

In the case where Table 2 is referenced again, regarding the corrosion resistance, discoloration was observed in Comparative Example 1 containing no Sn, but discoloration was not observed in Examples 1 to 7 and Comparative Example 2 in which the amount of Sn was set to 0.05% or more. That is, the corrosion resistance was improved by the addition of Sn.

According to the above-described results, it is possible to minimize the crystal grains of the metal powder by adding non-magnetic Sn within a scope in which the magnetic characteristics such as permeability are not sacrificed, and, in the obtained powder cores, particularly, it is possible to decrease the eddy current loss and the iron loss at a high frequency of 500 kHz or more and to improve the corrosion resistance. That is, the above-described powder core is particularly suitable for use in magnetic components used at a high frequency of 500 kHz or more. In addition, the shape of the metal powder can be made to be more spherical by the addition of Sn, and it is possible to improve the DC superposition characteristics. That is, in the case where the obtained powder core is used in a converter circuit or the like as a power supply, it is possible to suppress a decrease in inductance up to a high current value, and to maintain high conversion efficiency.

Next, the magnetic characteristics and corrosion resistance of the cores 10 obtained from metal powder having different amounts of Si and different amounts of Cr will be described.

First, regarding the amounts of Si, the initial permeability was as relatively high as 28 to 34 in Examples 5 and 8 to 15 in which the amounts of Si were set in a range of 0.5 mass % to 10 mass %, but was relatively low in both Comparative Example 3 containing no Si (27) and Comparative Example 4 having an amount of Si set to 11 mass % (26) as illustrated in Table 3. That is, the amount of Si has a component range in which the initial permeability is optimized. In addition, the DC magnetic field application reached the maximum in Comparative Example 3 containing no Si (147 Oe), and decreased as the amount of Si increased in Examples 8 to 12, 5, 13 to 15 and reached the minimum in Comparative Example 4 in which the amount of Si was set to 11 mass % (72 Oe). That is, the DC magnetic field application tends to decrease as the amount of Si increases. Furthermore, the iron loss reached the maximum in Comparative Example 3 containing no Si (15231 kW/m³), decreased as the amount of Si increased in Examples 8 to 12, 5, 13 to 15, and reached the minimum in Comparative Example 4 in which the amount of Si was set to 11 mass % (3498 kW/m³). That is, the iron loss tends to decrease as the amount of Si increases.

In addition, regarding the amounts of Cr, the initial permeability reached the maximum in Comparative Example 5 in which the amount of Cr was set to 1 mass % (34), decreased as the amount of Cr increased in Examples 16 to 18, 5 and 19 to 21, and reached the minimum in Comparative Example 6 in which the amount of Cr was set to 9 mass % (24) as illustrated in Table 4. That is, the initial permeability tends to decrease as the amount of Cr in the component composition increases. In addition, the DC magnetic field application reached the maximum in Comparative Example 5 in which the amount of Cr was set to 1 mass % (116 Oe), decreased as the amount of Cr increased in Examples 16 to 18, 5 and 19 to 21, and reached the minimum in Comparative Example 6 in which the amount of Cr was set to 9 mass % (94 Oe). That is, the DC magnetic field application decreased as the amount of Cr increased. Furthermore, the iron loss reached the minimum in Comparative Example 5 in which the amount of Cr was set to 1 mass % (5744 kW/m³), increased as the amount of Cr increased in Examples 16 to 18, 5, 19 to 21, and reached the maximum in Comparative Example 6 in which the amount of Cr was set to 9 mass % (7627 kW/m³). That is, the iron loss tends to increase as the amount of Cr increases. In addition, regarding the corrosion resistance, discoloration was observed in Comparative Example 5 in which the amount of Cr was set to 1 mass %, but discoloration was not observed in Examples 5, 16 to 21, and Comparative Example 6 in which the amount of Cr was set in a range of 1.5 mass % to 9 mass %.

Furthermore, as illustrated in Table 5, the DC magnetic field application was 89 Oe in Example 14 in which the amount of Sn was set to 1 mass %, but decreased to 73 Oe in Comparative Example 7 containing no Sn. In a case in which the amount of Si in the component composition was increased to 8 mass % as well, it is possible to improve the DC superposition characteristics by the addition of Sn. In addition, in Examples 22 and 23 in which the average particle diameters D50 were set to be larger (25.4 μm and 37.9 μm) than that of Example 14, the initial permeability became as great as 34 and 37 respectively, and the DC magnetic field application became as small as 82 Oe and 80 Oe respectively, which were still relatively high values. Meanwhile, the iron loss became as great as 4930 kW/m³ and 6122 kW/m³ respectively which were still relatively small values. That is, it is considered that, even when the average particle diameter of the metal powder is increased, it is possible to make the shape of the metal powder more spherical and decrease the size of the crystal grains by the addition of Sn. In addition, in Example 20 in which the content of Si was set to 6.5 mass %, and the content of Cr was set to 5 mass %, the initial permeability was as relatively great as 30, the DC magnetic field application was as relatively great as 88 Oe, and the iron loss was as relatively small as 5719 kW/m³.

The target value of each of the initial permeability, DC magnetic field application in the evaluation of the DC superposition characteristics, and iron loss was specified based on the above-described results of the evaluation tests. That is, the initial permeability is set to 24 or more, the DC magnetic field application is set to 80 Oe or more, and the iron loss is set to 7400 kW/m³ or less. Then, in the case where comprehensively determining the magnetic characteristics and the corrosion resistance in Tables 2 to 5, cores which satisfied all the target values of the magnetic characteristics and had corrosion resistance were determined as “O”, and cores which failed to satisfy all the target values of the magnetic characteristics and did not have corrosion resistance were determined as “X”.

Meanwhile, the range of the component composition of the molten metal 3 for obtaining the metal powder 1 according to the invention is specified in consideration of the above-described magnetic characteristics and corrosion resistance of the evaluation tests.

In the case where the content is too great or too small, Si decreases the permeability of composite magnetic bodies such as the obtained powder cores, and, in the case where the content is too small, Si increases the iron loss. In addition, in the case where the content is too great, Si degrades the DC superposition characteristics. Therefore, the content of Si is, in terms of mass %, in a range of 0.5% to 10.0%, preferably in a range of 1.0% to 8.0% and more preferably 1.5% or more.

Cr supplies corrosion resistance to powder and the obtained composite magnetic bodies; however, since Cr is not magnetic, in the case where the content of Cr is excessive, the permeability of the obtained composite magnetic body is decreased, and the iron loss increases. Therefore, the content of Cr is, in terms of mass %, in a range of 1.5% to 8.0%, preferably in a range of 2.0% to 6.0% and more preferably 3.0% or more.

Sn is not magnetic, and decreases the permeability of the obtained composite magnetic body in the case where the content is too great. Meanwhile, to give the effects of the invention so as to prevent an increase in the iron loss of the composite magnetic body, it is necessary to add a certain amount or more of Sn. Therefore, the content of Sn is, in terms of mass %, in a range of 0.05% to 3.0%, preferably in a range of 0.20% to 2.0% and more preferably 1.0% or less.

Meanwhile, unavoidable impurities can be contained as long as the above-described magnetic characteristics and corrosion resistance are not impaired, and, specifically, the acceptable contents thereof are as described in terms of mass %: C: 0.04% or less, Mn: 0.3% or less, P: 0.06% or less, 5: 0.06% or less, N: 0.06% or less, Cu: 0.05% or less, Mo: 0.05% or less, Ni: 0.1% or less, 0 (oxygen): 1% or less.

While the mode for carrying out the present invention has been described in detail above, the present invention is not limited to these embodiments, and various changes and modifications can be made therein without departing from the purport of the present invention.

Incidentally, this application is based on Japanese patent application No. 2013-042706 filed Mar. 5, 2013, and the entire contents thereof being hereby incorporated by reference.

### DESCRIPTION OF REFERENCE NUMERALS AND SIGNS

1 SOFT MAGNETIC METAL POWDER
10 CORE (POWDER CORE)

What is claimed is:

1. A soft magnetic metal powder, consisting of, in terms of mass %:
0.5% to 10.0% of Si,
1.5% to 8.0% of Cr, and
0.05% to 3.0% of Sn,
with the balance being Fe and unavoidable impurities.

2. A powder core obtained by pressure-forming a soft magnetic metal powder, wherein the soft magnetic metal powder consists of, in terms of mass %:
0.5% to 10.0% of Si,
1.5% to 8.0% of Cr, and
0.05% to 3.0% of Sn,
with the balance being Fe and unavoidable impurities.
